(19) United States
(12) Patent Application Publication
(10) Pub. No.: US 2020/0324567 A1
(43) Pub. Date: Oct. 15, 2020

(54) Laminated Card with Perforated Expandable Component

(71) Applicant: WILopEN Products, LC, Deerfield Beach, FL (US)

(72) Inventors: Corey Wilen, Plainview, NY (US); Gordon M. Kramer, Coral Springs, FL (US)

(73) Assignee: WILopEN Products, LC, Deerfield Beach, FL (US)

(21) Appl. No.: 16/845,302

(22) Filed: Apr. 10, 2020

Related U.S. Application Data
(60) Provisional application No. 62/832,633, filed on Apr. 11, 2019.

(51) Int. Cl. B42D 15/04; G09F 1/04; G09F 23/10

(52) U.S. Cl. CPC B42D 15/045; G09F 23/10; G09F 1/04; B42D 15/042

(57) ABSTRACT

A card for distributing advertising and information is described. The card, which can be laminated, includes a card body and an expandable component that is detachable from the card body. The expandable component includes two connected plies of material that are connected to form a closed end that is opposite to a detachment end at which the expandable component is detachable from the card body. The expandable component optionally may include one or more sheets of material that are arranged in a folded configuration between the two plies while the expandable component is still attached to the card body. Once the expandable component is detached from the card body, the expandable component is openable to reveal concealed printed matter printed on an interior surface.

### CROSS REFERENCE TO RELATED APPLICATIONS

This application is a nonprovisional application of and claims priority from U.S. provisional patent application Ser. No. 62/832,633, filed on Apr. 11, 2019. The foregoing application is incorporated in its herein by reference.

### FIELD OF THE INVENTION

The invention relates to advertising and publication of printed information. More particularly, the invention relates to a laminated card having an expandable component that is detachable from the card at a perforation, which can be used as a mailer or other advertising or informational printed item.

### BACKGROUND

Flyers, postcards, and other mailers are used to distribute advertising and information via mail, hand distribution, and other means of delivery. Many such printed pieces are made as a single sheet of paper or other material having a weight or thickness sufficient to endure delivery via mail service. Due to postal service regulations related to size and postal rate, most such printed pieces are standard flat postcards having dimensions (denoted in inches) such as 4.25″×5.5,″ 4″×6,″ 4.25″×6,″ 5″×7,″ 6″×8,″ 5.5″×8.5,″ 4″×9,″ 6″×9,″ and 6″×11.″ Some of those postcard variants may be folded in half for mailing or created in trifold configuration. Postcards that are 4″×6″ or smaller qualify for the United States Postal Service's first-class postcard rate, which is lower than postal rates for mailing letters, while larger sizes may be mailed at the more expensive standard letter or first-class letter rates. When distributing advertising and information to numerous recipients via mail, being able to take advantage of the lower rates for smaller postcard size variants can provide a substantial cost savings.

Many standard mailers are disregarded because they are letters that consumers discard without opening. Because large percentages of consumers never open such letter mailers, the advertising value is low.

A need exists for flyers, postcards, and other mailers for distributing advertising and information that meet certain size requirements while providing more surface area for printing than what is available on a single-sheet postcard. A further need exists for advertising pieces, systems, and methods that increase the value of advertising by inducing recipients to view the advertisement.

### SUMMARY

The invention relates to a card for distributing advertising and information is described. The card, which can be laminated, includes a card body and an expandable component that is detachable from the card body. The expandable component includes two connected plies of material that are connected to form a closed end that is opposite to a detachment end at which the expandable component is detachable from the card body. The expandable component optionally may include one or more sheets of material that are arranged in a folded configuration between the two plies while the expandable component is still attached to the card body. Once the expandable component is detached from the card body, the expandable component is openable to reveal concealed printed matter printed on an interior surface.

In one exemplary embodiment, the card for distributing advertising or information, the card is a card formed from at least two connected plies of material. The card includes a card body, and connected thereto, an expandable component that is detachable from the card body at a line of separation, which can be a line of perforation in some embodiments.

In another exemplary embodiment, the expandable component includes a sheet of material that is folded so as to be contained within the expandable component when the expandable component is attached to the card body. The expandable component is openable after detachment from the card body. Once the expandable component is detached from the card body, the sheet of material disposed within the expandable component is expandable by unfolding. Advertising, information, or other printed matter that is printed on one of both sides of the sheet of material is then viewable.

The card apparatus, advertising systems, and methods described herein provide advantages over traditional mailers and advertisements by meeting certain size requirements of the United States Postal Service and other mail and shipping services while providing more surface area for printing than what is available on a single-sheet postcard. These advertising pieces, systems, and methods also provide advantages by inducing recipients to view an advertisement by concealing certain printed matter (e.g., a discount or prize code) inside a detachable expandable component, thereby increasing the value of the advertising to an advertiser.

Accordingly, the invention features a card for distributing advertising or information. The card includes a card body and an expandable component that is connected to but detachable from the card body at a line of separation and is openable after detachment. The card is constructed from at least two plies of material, wherein some or all of the at least two plies of material are connected together at one or more locations. The card body and the expandable component form a single, unitary piece until the expandable component is detached from the card body.

In another aspect, the invention can feature the card body, the expandable component, or both including printed matter.

In another aspect, the invention can feature an interior surface of the expandable component including concealed printed matter that is viewable when the expandable component is detached from the card body.

In another aspect, the invention can feature the concealed printed matter printed on the interior surface of the expandable component being or including a code for obtaining a discount off a purchase price of goods or services or for obtaining a prize such as free goods or services or money.

In another aspect, the invention can feature the at least two plies of material being two plies.

In another aspect, the invention can feature the two plies being two halves of a single sheet of material that is folded in half, wherein the two halves are connected together at their inner surfaces.

In another aspect, the invention can feature a first end of the card being closed at a fold.

In another aspect, the invention can feature the card being or including a single sheet of material folded into two halves. A second end of the card is open but includes a first portion and a second portion that are generally coplanar and removably connected.

In another aspect, the invention can feature the card body and expandable component being configured so that a long side of the expandable component is connected to a short side of the card body.

In another aspect, the invention can feature the card having a first end and a second end. The first end is a closed end and the second end is an open end having a first portion and a second portion that are generally coplanar and removably connected. The first end of the card body is opposite to the closed end of the card body. The card body includes the first end, and the expandable component includes the second end.

In another aspect, the invention can feature the expandable component has a length of about 85.60 mm and a height of about 53.98 mm.

In another aspect, the invention can feature the expandable component being generally rectangular in shape and having rounded corners, wherein each rounded corner has a radius of about 2.88 mm to about 3.48 mm.

In another aspect, the invention can feature the expandable component being shaped and sized generally the same as a debit card or credit card.

In another aspect, the invention can feature the card further including a sheet of material that is folded so as to be contained within the expandable component when the expandable component is attached to the card body.

In another aspect, the invention can feature the sheet of material disposed within the expandable component being expandable by unfolding.

The invention also features an advertising system that includes a card body, an expandable component that is connected to but detachable from the card body at a line of separation and is openable after detachment, and concealed printed matter that is printed on the expandable component. The concealed printed matter is concealed when the expandable component is attached to the card body and is viewable upon detachment of the expandable component from the card body and opening of the expandable component. The card is constructed from at least two plies of material, and some or all of the at least two plies of material are connected together at one or more locations. The card body and the expandable component form a single, unitary piece until the expandable component is detached from the card body.

In another aspect, the invention can feature the concealed printed matter being printed on an interior surface of the expandable component or on a sheet of material that is folded so as to be contained within the expandable component when the expandable component is attached to the card body.

In another aspect, the invention can feature the advertising system further including a redemption system for reading the code to display on a display screen a discount or prize for which the code in the expandable component is redeemable.

The invention also features a method for advertising that induces a recipient to view, read, or examine an advertisement, the method including the step of: (a) providing a card for distributing advertising or information, the card including a card body and an expandable component that is connected to but detachable from the card body at a line of separation and is openable after detachment. The card is constructed from at least two plies of material, wherein some or all of the at least two plies of material are connected together at one or more locations. The card body and the expandable component form a single, unitary piece until the expandable component is detached from the card body. The method further includes the steps of: (b) delivering the card to a recipient; (c) detaching the expandable component from the card body; and (d) opening the expandable component to view concealed printed matter printed on the expandable component.

In another step of the method, the concealed printed matter is printed on an interior surface of the expandable component or on a sheet of material that is folded so as to be contained within the expandable component when the expandable component is attached to the card body.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a first side view of a card having a detachable expandable component.

FIG. 2 is a second side view of the card of FIG. 1.

FIG. 3 is a first side view of the expandable component detached from a card body of the card with the expandable component unopened.

FIG. 4 is a first side view of the expandable component in its open configuration

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

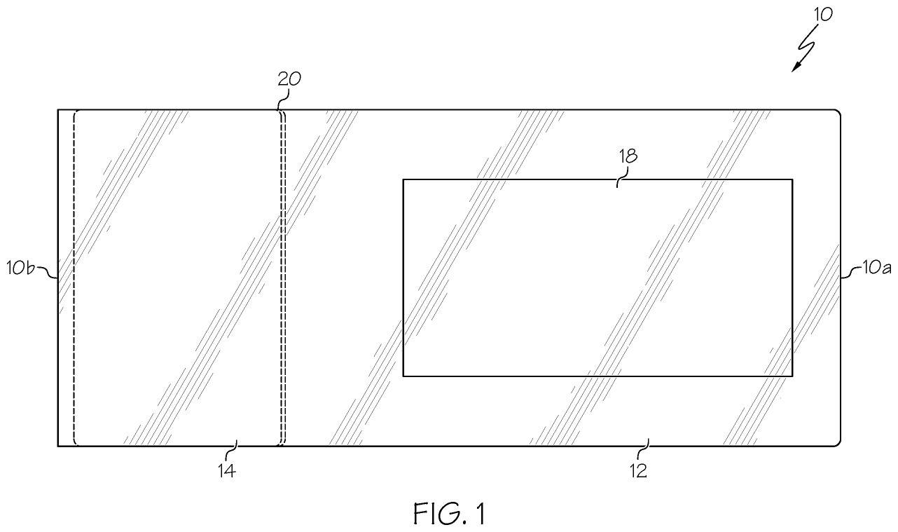

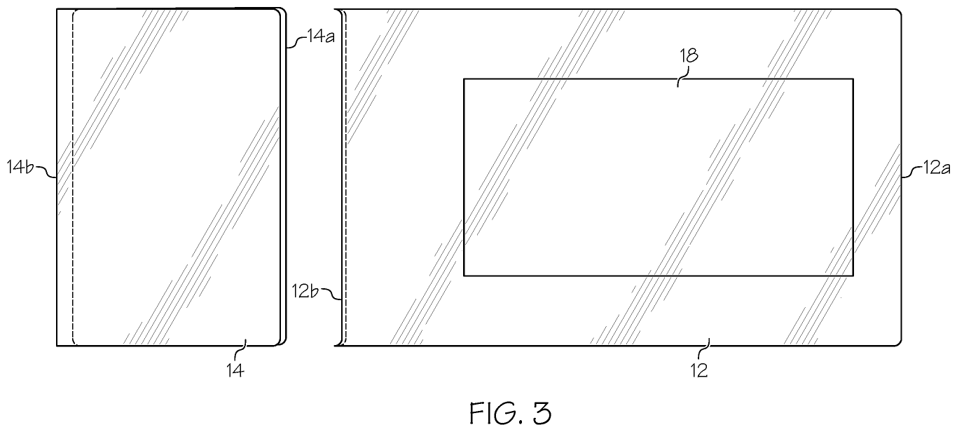

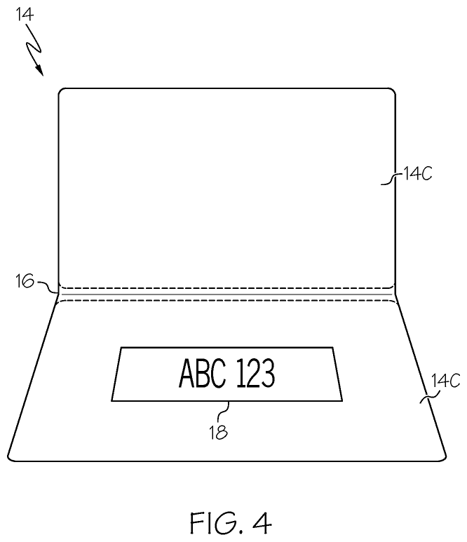

The invention provides a card 10 for distributing advertising or information. As shown in FIGS. 1-4, the card 10 includes a card body 12 and an expandable component 14 that is detachable from the card body. The card 10 has a first end 10a and a second end 10b. In most embodiments, the card 10 is generally rectangular in shape. The card 10 can have all of its sides being of equal length. However, in exemplary embodiments, the card 10 includes two opposing long sides and two opposing short sides. The card body 12 may form one end (e.g., the first end 10a) of the card 10, and the expandable component 14 may form the other end (e.g., the second end 10b) of the card 10.

The card body 12 has a first end 12a and a second end 12b. In most embodiments, the card body 12 is generally rectangular in shape. The card body 12 can have all of its sides being of equal length. However, in exemplary embodiments, the card body 12 includes two opposing long sides and two opposing short sides. At least one end of the card body 12 is closed, meaning that it is constructed from plies that are attached together and not intended to be unattached from one another. The closed end of the card body 12 can be one of its short ends in exemplary embodiments, or one of the card body's long ends in other embodiments. As described below, for example, the card 10 may be constructed from a single sheet of material folded in half at a fold 16. The fold 16 can be located at the first end 12a of the card body 12. In some embodiments, the two sides (e.g., the long sides) of the card body 12 that are adjacent to the first end 12a may be closed (i.e., sealed, connected, attached, or otherwise constructed in a manner not intended to be opened). In some embodiments, the second end 12b of the card body 12, which can be the end to which the expandable component 14 is removably attached, can be open or openable. In such embodiments, the card body 12 might also be openable after detachment of the expandable component 14. Concealed printed matter 18, as described elsewhere herein, may be printed on an inner surface of the card body in such embodiments. In exemplary embodiments, the expandable component 14 is removably attached to the second end 12b of the card body 12, which is opposite to the first end 12a of the card body.

The expandable component 14 has a first end 14a and a second end 14b and at least two inner surfaces 14c. In most embodiments, the expandable component 14 is generally rectangular in shape. The expandable component 14 can have all of its sides being of equal length. However, in exemplary embodiments, the expandable component 14 includes two opposing long sides and two opposing short sides. At least one end of the expandable component 14 is closed, meaning that it is constructed from plies that are attached together and not intended to be unattached from one another. The closed end of the expandable component 14 can be one of its long ends in exemplary embodiments, or one of the expandable component's short ends in other embodiments. As described below, for example, the card 10 may be constructed from a single sheet of material folded in half at a fold 16. The fold 16 can be located at the second end 14b of the expandable component 14. The first end 14a of the expandable component 14, which can be the end to which the card body 12 is removably attached, can be open or openable. The expandable component 14 is openable after detachment of the expandable component from the card body 12. Concealed printed matter 18, as described elsewhere herein, may be printed on an inner surface 14c of the expandable component 14.

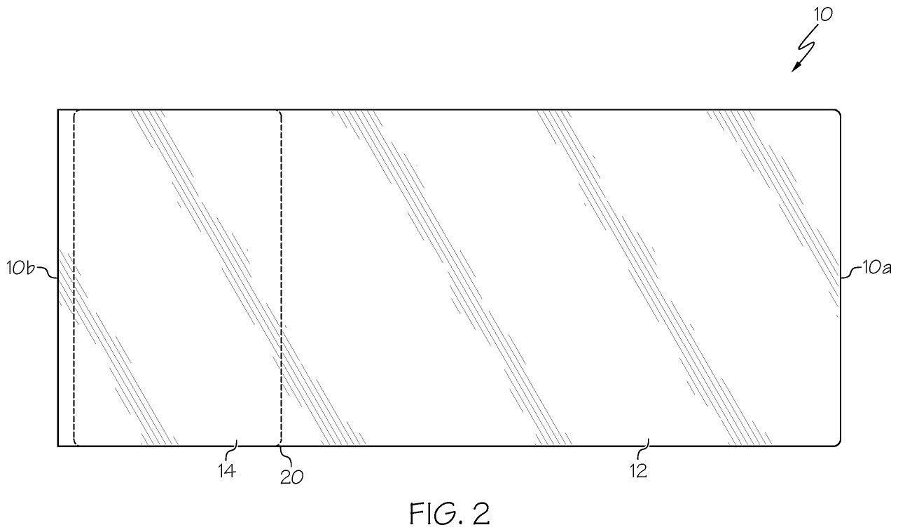

The card 10 may be constructed so that a long end of the expandable component 14 is connected to a short end of the card body 12 as shown in FIGS. 1-2. In other embodiments, a short end of the expandable component 14 may be connected to a long end of the card body 12. In still other embodiments, a long end of the expandable component 14 may be connected to a long end of the card body 12. In yet other embodiments, a short end of the expandable component 14 may be connected to a short end of the card body 12.

The card 10 is constructed from at least two connected plies of material so that one ply of the material forms a front side of the card and the other ply of material forms the rear side of the card. In some embodiments, more than two (e.g., 3, 4, 5, 6, 7, 8, or more) plies of material may be used to create the card 10; however, for convenience, examples presented herein will be described as having two plies of material. In exemplary embodiments, the two plies of material are two halves of a single sheet of material that is folded in half so that each of its halves may be connected together at their inner surfaces. The two halves may be connected together at their inner surfaces, for example, using an adhesive or lamination. In these embodiments, a first end of the card is closed in that it includes the fold at which the single sheet of material was folded into two halves, and a second end of the card is open but connected meaning that it includes an end of each half of the folded single sheet of material now connected together by the adhesive or other attachment means (e.g., lamination, tape, or a staple). This open but connected end forms an end of the card body 12 that is opposite from the closed end 14b of the card 10, which forms an end of the expandable component 14. The card 10 is closed at one end at the fold 16. The second end 10b of the card 10 can be open but includes a first portion and a second portion that are generally coplanar and removably connected. The first end 12a of the card body 12 can be opposite to the closed end of the card body. The card body 12 includes the first end 10a of the card 10, and the expandable component 14 includes the second end 10b of the card 10.

In other embodiments, the first end 10a of the card 10 can be open and the second end 10b of the card 10 can be closed. In still other embodiments, the first end 10a of the card 10 can be closed and the second end 10b of the card 10 can be open. In yet other embodiments, the first end 10a of the card 10 can be closed and the second end 10b of the card 10 can be closed. In further embodiments, the first end 10a of the card 10 can be open and the second end 10b of the card 10 can be open.

The material from which the card 10 is constructed can be paper, plastic, foil, any other suitable material that can be created in sheets, or a combination of two or more of the foregoing. For example, in some embodiments, the card body 12 may be constructed from one material and the expandable component 14 may be constructed from a second different material. In other embodiments, each ply of the card 10 may be a different type of material, or at least one ply may be a material that is different than the material of the other ply or plies of the card.

At least one surface of the card 10 may be laminated, i.e., include an attached film of plastic or other material. For example, an outer face of the front ply of material, an outer face of the rear ply of material, or both outer faces of both plies of material may be laminated. In some embodiments, one or more inner surfaces of the expandable component 14, card body 12, or both may also be laminated.

The card body 12 and the expandable component 14 initially form a single, unitary piece. The expandable component 14 is detachable from the card body 12 and is openable after detachment. In an exemplary embodiment, the two plies of material are connected so as to form a single sheet as the card body 12. However, where the expandable component 14 begins and the card body 12 ends, the two plies of material are not connected at their inner surfaces, thereby permitting the expandable component to be opened once it is detached from the card body. In some embodiments, the expandable component 14 may form a multi-page (e.g., 2, 3, 4, 5, 6, 7, 8, 9, 10, 20, or more pages) booklet once it is detached from the card body 12. When detached from the card body 12, the expandable component 14 includes a closed end (which is the closed end of the card when the card is still in its unitary, single-piece form before detachment of the expandable component) and an open end. The open end of the expandable component 14 is at an end where the expandable component was detached from an end of the card body 12, e.g., at a line of separation 20 or a line of perforation 20.

In exemplary embodiments, the card body 12 and expandable component 14 are configured so that a long side of the expandable component is connected to a short side of the card body.

Once detached from the card body 12, the expandable component 14 is openable at its open end. When opened, the expandable component 14 has two pages that are openable and closable and may include printed matter 18 printed on their inner surfaces 14c.

The card body 12, the expandable component 14, or both can include printed matter 18. For example, concealed printed matter 18a can be printed on an interior surface 14c of the expandable component 14 so as to be viewable when the expandable component is detached from the card body 12. The concealed printed matter 18a printed on the interior surface 14c of the expandable component 14 can include a code for obtaining a discount off a purchase price of goods or services or for obtaining a prize such as free goods or services or money.

In some embodiments, the expandable component 14 is shaped and sized to conform to the ISO/IEC 7810 ID-1 standard (about 85.60 mm long by about 53.98 mm high (about 3⅜ inches long by about 2⅛ inches high). This standard size used for the expandable component 14 in some embodiments, which is the same as the size used for payment cards, is also called CR-80. In some embodiments such as those that meet the foregoing ISO/IEC 7810 ID-1 standard or CR-80 standards, the expandable component 14 has rounded corners, for example, with a radius of about 2.88 mm to about 3.48 mm. In other embodiments, the expandable component 14 may have angular corners. The foregoing dimensions, including rounded corner dimensions, are the same as those used for CR-80 debit and credit cards as well as many gift cards and other payment cards. In some of these embodiments, the expandable component 14 may include a gift card, debit card, credit card, other payment card, discount card, coupon, or scrip. For example, one half of the expandable component 14 may be one of the foregoing types of cards, coupons, or scrips that is separable from the other half of the expandable component. In other embodiments, each half of the expandable component 14 may constitute its own separate gift card, debit card, credit card, other payment card, discount card, coupon, or scrip.

In some embodiments of the card 10, the card further includes a sheet of material that is folded so as to be contained within the expandable component 14 when the expandable component is attached to the card body 12. The sheet of material disposed within the expandable component 14 is expandable by unfolding. Once unfolded, advertising, information, or other printed matter that is printed on the single sheet of material may be viewed. The single sheet of material may be, for example, a letter size (i.e., 8.5 inches by 11 inches) or legal size (i.e., 8.5 inches by 14 inches) sheet of material or any other size that may be folded for attachment or insertion within the expandable component. The single sheet of material can be paper, plastic, foil, or any other suitable material that can be created in sheets. The single sheet of material includes only a single ply in exemplary embodiments but may include two or more connected plies in other embodiments. The single sheet of material may be attached to an inner surface of the expandable component, for example, by adhesive, or it may be inserted loosely inside the expandable component. The single sheet of material can be removable from the expandable component or securely fixed therein. FIGS. 1-4 do not show a sheet of material included inside the expandable component 14.

The invention also relates to an advertising system that includes an advertising piece (i.e., a card) as described herein above. For example, the advertising piece can include a card body, an expandable component that is connected to but detachable from the card body at a line of separation and is openable after detachment, and concealed printed matter that is printed on the expandable component. The concealed printed matter is concealed when the expandable component is attached to the card body and is viewable upon detachment of the expandable component from the card body and opening of the expandable component. The card is constructed from at least two plies of material, and some or all of the at least two plies of material are connected together at one or more locations. The card body and the expandable component form a single, unitary piece until the expandable component is detached from the card body.

In various embodiments, the concealed printed matter can be printed on an interior surface of the expandable component or on a sheet of material that is folded so as to be contained within the expandable component when the expandable component is attached to the card body.

The advertising system can further include a redemption system for reading the code to display on a display screen a discount or prize for which the code in the expandable component is redeemable. The redemption system can include a software application (or “app”), or a website that is accessible via a web browser, on a computing device for checking the code to determine the amount or type of discount or prize to which the recipient may be entitled. The redemption system may further make use of a laser or optical scanner to read or recognize the code, e.g., where the code is a bar code or QR code, so that redemption system displays, announces, or otherwise conveys the amount or type of prize associated with the code. For example, the laser or optical scanner can be an integral part of a camera system of a mobile phone, tablet computer, or other computing device. In other embodiments, the redemption system may include an input device (e.g., a keyboard, touchscreen, scanner, RFID (radio-frequency identification) device, or microphone) that is an integral part of or connected to the computing device to allow for manual or voice entry of the code, which can include alphanumeric text. The display screen can be an integral part of a computing device (e.g., a mobile phone, laptop computer, or tablet computer) or connected to the computing device (e.g., a display screen that is connected to a desktop computer).

The advertising system can also include delivery systems for delivering or distributing the advertising card to recipients. Examples of delivery systems include mail services, shipping services, vending machines (e.g., for distributing newspapers or magazines).

The invention also relates to methods for advertising that induce a recipient to view, read, or examine an advertisement. The method includes the step of providing a card for distributing advertising or information such as those described herein above. For example, the card can include a card body and an expandable component that is connected to but detachable from the card body at a line of separation and is openable after detachment. The card is constructed from at least two plies of material, wherein some or all of the at least two plies of material are connected together at one or more locations. The card body and the expandable component form a single, unitary piece until the expandable component is detached from the card body. In a next step, the method further includes the step of delivering the card to a recipient, e.g., a consumer such a potential customer, a former customer, or an existing customer. In a next step, the method further includes the step of detaching the expandable component from the card body. In a next step, the method further includes the step of opening the expandable component to view concealed printed matter printed on the expandable component.

In some embodiments of the method, the concealed printed matter is printed on an interior surface of the expandable component. In other embodiments of the method, the concealed printed matter is printed on a sheet of material that is folded so as to be contained within the expandable component when the expandable component is attached to the card body.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A card for distributing advertising or information, the card comprising:
a card body; and
an expandable component that is connected to but detachable from the card body at a line of separation and is openable after detachment;
wherein the card comprises at least two plies of material, wherein some or all of the at least two plies of material are connected together at one or more locations;
wherein the card body and the expandable component comprise a single, unitary piece until the expandable component is detached from the card body.

2. The card of claim 1, wherein the card body, the expandable component, or both comprises printed matter.

3. The card of claim 1, wherein an interior surface of the expandable component comprises concealed printed matter that is viewable when the expandable component is detached from the card body.

4. The card of claim 3, wherein the concealed printed matter printed on the interior surface of the expandable component comprises a code for obtaining a discount off a purchase price of goods or services or for obtaining a prize comprising free goods or services or money.

5. The card of claim 1, wherein the at least two plies of material comprise two plies.

6. The card of claim 5, wherein the two plies comprise two halves of a single sheet of material that is folded in half, wherein the two halves are connected together at their inner surfaces.

7. The card of claim 1, wherein a first end of the card is closed at a fold.

8. The card of claim 7, wherein the card comprises a single sheet of material folded into two halves; wherein a second end of the card is open but comprises a first portion and a second portion that are generally coplanar and removably connected.

9. The card of claim 1, wherein the card body and expandable component are configured so that a long side of the expandable component is connected to a short side of the card body.

10. The card of claim 1, wherein the card comprises a first end and a second end; wherein the first end is a closed end and the second end is an open end comprising a first portion and a second portion that are generally coplanar and removably connected; wherein the first end of the card body is opposite to the closed end of the card body; and wherein the card body comprises the first end and the expandable component comprises the second end.

11. The card of claim 1, wherein the expandable component comprises a length of about 85.60 mm and a height of about 53.98 mm.

12. The card of claim 1, wherein the expandable component is generally rectangular in shape and comprises rounded corners, wherein each rounded corner comprises a radius of about 2.88 mm to about 3.48 mm.

13. The card of claim 1, wherein the expandable component is shaped and sized generally the same as a debit card or credit card.

14. The card of claim 1, wherein the card further comprises a sheet of material that is folded so as to be contained within the expandable component when the expandable component is attached to the card body.

15. The card of claim 2, wherein the sheet of material disposed within the expandable component is expandable by unfolding.

16. An advertising system comprising:
a card body;
an expandable component that is connected to but detachable from the card body at a line of separation and is openable after detachment; and
concealed printed matter that is printed on the expandable component, wherein the concealed printed matter is concealed when the expandable component is attached to the card body and is viewable upon detachment of the expandable component from the card body and opening of the expandable component;
wherein the card comprises at least two plies of material, wherein some or all of the at least two plies of material are connected together at one or more locations;
wherein the card body and the expandable component comprise a single, unitary piece until the expandable component is detached from the card body.

17. The advertising system of claim 16, wherein the concealed printed matter is printed on an interior surface of the expandable component or on a sheet of material that is folded so as to be contained within the expandable component when the expandable component is attached to the card body.

18. The advertising system of claim 17, further comprising a redemption system for reading the code to display on a display screen a discount or prize for which the code in the expandable component is redeemable.

19. A method for advertising that induces a recipient to view, read, or examine an advertisement, the method comprising the steps of:
(a) providing a card for distributing advertising or information, the card comprising:
a card body; and
an expandable component that is connected to but detachable from the card body at a line of separation and is openable after detachment;
wherein the card comprises at least two plies of material, wherein some or all of the at least two plies of material are connected together at one or more locations;
wherein the card body and the expandable component comprise a single, unitary piece until the expandable component is detached from the card body;
(b) delivering the card to a recipient;
(c) detaching the expandable component from the card body; and
(d) opening the expandable component to view concealed printed matter printed on the expandable component.

20. The method of claim 19, wherein the concealed printed matter is printed on an interior surface of the expandable component or on a sheet of material that is folded so as to be contained within the expandable component when the expandable component is attached to the card body.
